(19) United States
(12) Patent Application Publication
(10) Pub. No.: US 2005/0247878 A1
(43) Pub. Date: Nov. 10, 2005

(54) Infrared gas sensor

(76) Inventors: Dieter Baschant, Vockerode (DE); Heinz Gatzmanga, Koethen (DE); Heinz Juppe, Dessau (DE); Hermann Stahl, Nidderau-Ostheim (DE)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 11/054,543

(22) Filed: Feb. 10, 2005

(30) Foreign Application Priority Data
Feb. 11, 2004 (DE) 102004006677.9

(51) Int. Cl. G01N 21/35

(52) U.S. Cl. 250/343

(57) ABSTRACT

The invention relates to an infrared gas sensor for determining the concentration of a measuring gas that absorbs infrared radiation, comprising a sensor housing containing two infrared radiation detectors adjacently situated on one end of a measurement beam path, and on the other end containing a measurement radiation source that emits infrared radiation. According to the invention, a measuring chamber accessible to the measuring gas is situated in the measurement beam path between the measurement radiation source and the detectors, at a distance from the detectors and sealed essentially gastight with respect to the remainder of the measurement beam path by at least one infrared-transmitting window. Upstream from one detector, which functions as a measurement detector, an interference filter is provided whose transmission region lies at wavelengths that are absorbed by the measuring gas, and upstream from the other detector, which functions as a reference detector, an interference filter is provided whose transmission region lies at wavelengths that are not absorbed by gas that is present in the measuring chamber and in the measurement beam path. The invention is further characterized by the fact that an auxiliary radiation source is also provided inside the housing, and between this auxiliary radiation source and the detectors an auxiliary beam path is situated which is not accessible to the measuring gas and which is connected to the portion of the measurement beam path that is not accessible to the measuring gas, so that the same gas composition is present in the entire portion of the measurement beam path that is not accessible to the measuring gas and in the auxiliary beam path, the system being selected in such a way that the measurement detector and reference detector can receive optical signals from both the measurement radiation source and the auxiliary radiation source.

The invention relates to an infrared gas sensor for determining the concentration of a measuring gas that absorbs infrared radiation, comprising a sensor housing containing two infrared radiation detectors adjacently situated on one end of a measurement beam path, and on the other end containing a measurement radiation source that emits infrared radiation, a measuring chamber accessible to the measuring gas being situated in this measurement beam path between the measurement radiation source and the detectors, at a distance from the detectors and sealed essentially gastight with respect to the remainder of the measurement beam path by at least one infrared-transmitting window; upstream from one detector, which functions as a measurement detector, an interference filter being provided whose transmission region lies at wavelengths that are absorbed by the measuring gas, and upstream from the other detector, which functions as a reference detector, an interference filter being provided whose transmission region lies at wavelengths that are not absorbed by gas that is present in the measuring chamber and in the measurement beam path.

The principle of measuring the concentration of a gas by infrared absorption is basically known. In addition, the design of optical gas analyzers and the application of measuring methods to compact infrared gas sensors is amply described in the literature. The following are mentioned as examples: Staab, J. L., Industrielle Gas analyse [Industrial Gas Analysis], Oldenbourg Verlag München, Vienna 1994; Wiegleb et al.: Industrielle Gassensorik [Industrial Gas Sensor Technology], expert verlag, Renningen-Malmsheim 2001, and patents DE 102 21 708 A1, DE 298 00 070 U1, DE 39 18 994 C1, DE 197 13 928 C1, and DE 101 38 302 A1.

The known measurement methods are based on the principle that the absorption of infrared radiation by a gas at specific wavelengths is proportional to the number of gas molecules in an irradiated volume. A simple design of a sensor for concentration measurement comprises a chamber that is accessible to the gas whose concentration is to be determined, on one side of the chamber an infrared radiation source being situated, and on the opposite side of the chamber radiation detectors being situated which detect both radiation at a wavelength that is absorbed by the gas and radiation at a reference wavelength that is not absorbed by the gas. However, such simple systems and the sensors and measurement methods described in the literature usually are suited only for operating temperatures below 80° C., since radiation receivers and measurement electronics in particular may be damaged at higher temperatures. For measurements of high-temperature gas, as well as for sterilization processes, however, the ability to operate also at higher temperatures is desirable. For this reason, dead spaces are provided between the gas measurement path and the radiation emitter and radiation receiver for better temperature compatibility. Such structures are generally very complex or likewise limited in their temperature range. In addition, interfering gas concentrations appear in the dead spaces as well as in the radiation detectors as the result of degassing or adsorption/desorption effects caused by high temperature loads during sterilization, for example. This is the case in particular for important CO₂ measurement. Adsorption of interfering gas concentrations into the dead spaces distorts the results of absorption measurement of the gas measurement path. The measured absorption can then be used as a measure of the concentration of the measuring gas in the gas measurement path only if there are actually no measuring gas molecules present in the dead spaces, or the concentration thereof can at least be held stable. Otherwise, even for a zero gas concentration in the gas measurement path, a measured value different from zero would be obtained. To correct such a zero point shift it is necessary to distinguish whether the shift is attributable to a maladjustment of the lens and is correctable by a new zero point adjustment, or whether the shift is caused by an interfering gas concentration in the dead spaces. In this case, due to linearity characteristics and system sensitivity a multipoint calibration must generally be performed. To make this distinction, it is necessary to know the gas composition and the absorption into the dead spaces.

When changes in the gas concentration in the dead spaces occur only because of high temperatures during sterilization processes, it is sufficient to limit this distinction decision to discontinuous correction processes. Otherwise, if the gas concentrations in the dead spaces temporarily fluctuate due to leaks in the gas line or degassing effects during the measurement, this decision process must be continuously incorporated into the measurement method.

Accordingly, an object of the invention is to provide an infrared gas sensor that can be exposed to high temperatures, and that despite possible degassing and partial leaks in the system ensures high measurement accuracy over a long period, and that has a compact design and at the same time can be economically manufactured. It is a further object of the invention to provide a method for determining the concentration of a gas that absorbs infrared radiation by use of such an infrared gas sensor.

The object is achieved by the invention according to independent apparatus claim 1, and by a method according to independent method claim 11. Advantageous refinements and method variants of the invention are described in the dependent claims.

An infrared gas sensor according to the invention for determining the concentration of a measuring gas that absorbs infrared radiation comprises a sensor housing containing two infrared radiation detectors adjacently situated on one end of a measurement beam path, and on the other end containing a measurement radiation source that emits infrared radiation. According to the invention, a measuring chamber accessible to the measuring gas is situated in the measurement beam path between the measurement radiation source and the detectors, at a distance from the detectors and sealed essentially gastight with respect to the remainder of the measurement beam path by at least one infrared-transmitting window. Upstream from one detector, which functions as a measurement detector, an interference filter is provided whose transmission region lies at wavelengths that are absorbed by the measuring gas, and upstream from the other detector, which functions as a reference detector, an interference filter is provided whose transmission region lies at wavelengths that are not absorbed by gas that is present in the measuring chamber and in the measurement beam path. The invention is further characterized by the fact that an auxiliary radiation source is also provided inside the housing, and between this auxiliary radiation source and the detectors an auxiliary beam path is situated which is not accessible to the measuring gas and which is connected to the portion of the measurement beam path that is not accessible to the measuring gas, so that the same gas composition is present in the entire portion of the measurement beam path that is not accessible to the measuring gas and in the auxiliary beam path, and that the system is selected in such a way that the measurement detector and reference detector can receive optical signals from both the measurement radiation source and the auxiliary radiation source.

The measurement beam path suitably runs in a straight line inside the sensor housing, in a direct line between the measurement radiation source and the detectors, thus resulting in a particularly compact sensor design. Complex beam guide structures with tilted mirrors are not necessary. The detectors are adjacently situated, i.e., next to or on top of one another. The detectors preferably adjoin one another as closely as possible to ensure that both detectors are struck by the measurement radiation source and the auxiliary radiation source. In one refinement, the detectors are mounted together in a housing with the interference filters. This may basically involve two identical detectors, or also different models. Since it is intended that both detectors detect radiation from the same beam paths, it is practical for them to be configured in parallel, or at least approximately parallel, so that the radiation can enter both detectors at the same angle. If a beam splitter is used for distributing radiation from a ray bundle to the two detectors, it may be practical or necessary to tilt both detector openings with respect to one another.

The gas whose concentration is to be determined is located in a measuring chamber. This measuring chamber is situated in the measurement beam path between the radiation detectors at one end and the measurement radiation source at the other end. As a rule, the measuring chamber is sealed gastight with respect to the remainder of the measurement beam path by two infrared-transmitting windows. Infrared radiation can enter the measuring chamber through the first infrared-transmitting window on the side facing the measurement radiation source. After the measuring gas has been irradiated in the measuring chamber, it exits through the second window in the direction of the radiation detectors. In this manner, two dead spaces for thermal decoupling of the measuring gas and optical components in the measurement beam path are separated from the measuring chamber. The first dead space is situated between the measuring chamber and the radiation detectors. Both dead spaces are connected to one another so that they both contain the same gas atmosphere.

It is essential for the functioning of the sensors that the transmission regions of the interference filters, which are situated upstream from the measurement detector and the reference detector, are suitably selected for the measuring gas. In this regard, the transmission region of the interference filter upstream from the measurement detector must be transparent to wavelengths that are absorbed by the measuring gas present in the measuring chamber. The signal received in the measurement detector is consequently attenuated by a measuring gas concentration in the measuring chamber. This is referred to below as an absorption signal. To determine the magnitude of the absorption, for comparison purposes a wavelength is measured in the reference detector which is not absorbed in the measurement beam path. This means that the wavelength cannot be absorbed by any gas component present in the measuring chamber or in the reminder of the measurement beam path. This signal is referred to as the reference signal. By use of the absorption signal and the reference signal a measured value can then be generated which is proportional to the number of measuring gas molecules in the measurement beam path.

However, infrared radiation present in the transmission region of the measurement detector may also be absorbed by gases in the dead spaces. Such interfering gas concentrations in the dead spaces may result, for example, from degassing effects or leaks in the gas line system. Absorption effects that appear in the dead spaces due to such as interfering concentrations, and which thus distort the results for the absorption into the measuring chamber, are determined using an auxiliary beam path. Also for the auxiliary beam path, which is connected to the dead spaces of the measurement beam path and which thus also has the same gas composition, an absorption value is determined in the same manner as for the measurement beam path. This absorption value is then used to correct the measured value for the measuring chamber. The auxiliary beam path, likewise as for the measurement beam path, preferably runs in a straight line between the auxiliary radiation source and the detectors. The auxiliary beam path and the measurement beam path overlap one another upstream from the detectors, and irradiate the detectors in equal measure. The auxiliary beam path may also be contained within the measurement beam path, as discussed in greater detail below.

In this manner an infrared gas sensor for determining the concentration of a measuring gas that absorbs infrared radiation may be designed to be very compact. All essential components are contained within a sensor housing. In addition, the infrared gas sensor according to the invention is temperature-resistant, since the gas chamber is insulated with respect to the optical components by the dead spaces, thereby causing thermal decoupling to occur. Errors resulting from interfering gas concentrations are corrected by the measurement in the auxiliary beam path, so that a correct measurement result can be obtained. A costly second set of detectors for a complete second measurement path may be dispensed with by the common use of the detectors for the measurement beam path and the auxiliary beam path.

In one preferred refinement, a beam splitter is installed upstream from the interference filters of both detectors, so that the ray bundles which strike the measurement detector and the reference detector come from the very same ray bundle. This has the advantage that refraction and boundary effects from the beam paths do not play a role in a correct measurement result.

Preferably, the measurement beam path and auxiliary beam path can be electrically modulated and independently controlled. The independent control has the advantage that the outputs from the measurement radiation source and auxiliary radiation source can be coordinated with one another in such a way that, when the measuring gas concentration in the measuring chamber is zero, the signals measured in the detectors during irradiation by only one of the two radiation sources have essentially the same value, or are at least within the same order of magnitude (within a power of ten). In this manner, excessively large measurement-related errors may be avoided in the correction. In addition, the radiation sources preferably can be electrically modulated; i.e., they can be controlled at specific frequencies or voltage curves. When the measurement radiation source and auxiliary radiation source are operated, for example, at different frequencies or with a phase shift, re-separated signals can be derived for the auxiliary beam path and measurement beam path from a common detector signal measured simultaneously for both beam paths, using an appropriate signal processing device.

In one preferred embodiment of the infrared gas sensor, the optical axis of the measurement beam path and/or the optical axis of the auxiliary beam path coincides with a surface normal on a plane encompassing the measurement detector opening as well as with a surface normal on the plane encompassing the reference detector opening, or forms an acute angle thereto. As a rule, the measurement detector and reference detector are identically aligned and have their openings in one plane. In that case, the optical axes preferably strike the plane encompassing the detector openings between the two detectors, perpendicularly or at an acute angle to the surface normal. Basically, it is favorable for the radiation to strike the detectors at an angle that is as large as possible, close to 90°. However, since the measurement beam path and auxiliary beam path may possibly be tilted with respect to one another at an acute angle between 0° and 90°, the angle of incidence into the detectors must also vary within this range. In certain refinements of the infrared gas sensor according to the invention, the detectors are accommodated together in one housing in which the radiation enters through a single opening. In this case, the housing opening may be regarded as a common detector opening. The optical axes of both the measurement beam path and the auxiliary beam path then strike the plane of the housing opening, perpendicularly or at an acute angle to the surface normal. If the measurement beam path and auxiliary beam path are tilted with respect to one another in the horizontal direction, or the radiation sources are situated horizontally adjacent to one another in the sensor housing, it is practical to vertically position the two detectors one on top of the other. The optical axes of the measurement radiation source and the auxiliary radiation source then preferably meet at the vertical center between both detectors and in the horizontal center of the two detector openings at the described angles, parallel to the surface normal on the detector openings or at an acute angle thereto.

The measurement radiation source and/or auxiliary radiation source are preferably thermal radiators that can be modulated, in particular incandescent bulbs. Both the measurement radiation source and auxiliary radiation source may be additionally equipped with a reflector, which may have a parabolic or elliptical shape. In this regard, it is practical to design the dimensions of the reflectors to correspond to the distance between the radiation source and the detectors, or to the average distance of the radiation sources from the detectors.

If particularly high temperatures are not required for the measurement, the first dead space in the measurement beam path between the measurement radiation source and the measuring chamber may be omitted. The measurement radiation source is then preferably integrated into the measuring chamber. In this case, only one infrared-transmitting window is necessary for separating the measuring chamber from the dead spaces. This embodiment variant is characterized by its particularly compact design.

In an additional preferred embodiment, the measurement beam path and auxiliary beam path are situated in the sensor housing in such a way that the optical axes of both beam paths open up into a V shape from an intersection point in the vicinity of the detector openings toward the radiation sources. The auxiliary radiation source then irradiates both detectors past the measuring chamber in the measurement beam path. This variant has the advantage that the length of the auxiliary beam path may be adapted to the length of the dead spaces in the measurement beam path. It is then unnecessary to perform additional equalization of the outputs of the radiation sources for a comparable detector signal when the measuring gas concentration in the measuring chamber is zero.

Another preferred embodiment variant is implemented using an even more compact and simple design. Accordingly, the auxiliary radiation source is situated in the measurement beam path between the measuring chamber and the detectors. The measurement beam path and auxiliary beam path then partially coincide. In this regard, the auxiliary radiation source may be positioned on the optical axis of the measurement beam path, or may be laterally shifted relative to the center of the beam path. If the measurement radiation source has a reflector which radiates the primary radiation intensity in an annular shape about the optical axis, it may be practical to place the auxiliary radiation source directly on the optical axis. In this manner only a small proportion of the measurement radiation is shielded by the auxiliary radiation source. If the auxiliary radiation source lies on the optical axis of the measurement beam path, the optical axes of the auxiliary beam path and the measurement beam path coincide. If, on the other hand, the auxiliary radiation source is moved from the center of the measurement beam path, the optical axis of the auxiliary beam path runs at an acute angle to the optical axis of the measurement beam path. Depending on whether a first dead space is present between the measurement radiation source and the measuring chamber, or depending on the length of the first dead space, the auxiliary beam path is considerably shortened with respect to the dead space in the measurement beam path. When irradiation is performed by only radiation source at a time and the measuring gas concentration in the measuring chamber is zero, comparison of the signals received in the detector must then be carried out by controlling the output of the auxiliary radiation source or by appropriate positioning of the auxiliary radiation source in the measurement beam path. The shift in position may result in a lengthening or shortening of the auxiliary beam path, or, if the shift is transverse to the beam path, may result in a tilting of the optical axis of the auxiliary beam path.

In any case, the radiation from the auxiliary radiation source should be aligned in the direction of the detectors, and back reflection in the direction of the measurement radiation source through the measuring chamber should be avoided. This can be accomplished by a shading screen, for example.

For this exemplary embodiment, the auxiliary radiation source should preferably be as small as possible so that the least possible amount of radiation from the measurement radiation source is shaded with respect to the measurement detector. This may be achieved by a microtube lamp or a specially shaped wire filament without a glass tube. For shading in the direction of the measuring chamber, a microtube lamp may then, for example, be inserted into a tube, made of Teflon for example, that is cut out in the direction facing the detector.

The object of the invention is also achieved by a method for measuring the concentration of a measuring gas that absorbs infrared radiation by using an infrared gas sensor according to the invention, upstream from the measurement detector an interference filter being provided whose transmission region lies at wavelengths that are absorbed by the measuring gas, and upstream from the reference detector an interference filter being provided whose transmission region lies at wavelengths that are not absorbed by the measuring gas and other gas components present in the measurement beam path and auxiliary beam path. According to the invention, when the measurement radiation source in the measurement detector is switched on, an absorption signal that is attenuated as the result of absorption by the measuring gas is received in the transmission region of the interference filter provided upstream from the measurement detector, and in the reference detector an unattenuated reference signal is received in the transmission region of the interference filter provided upstream from the reference detector. These signals are relayed to a signal processing device in which a measured value is generated from the absorption signal and reference signal, the measured value being proportional to the number of measuring gas molecules in the measurement beam path. When the auxiliary radiation source is switched on, a measured value is generated in the same manner, which is proportional to the number of measuring gas molecules in the auxiliary beam path. Using this measured value for the auxiliary beam path, the measured value for the measurement beam path is corrected so that the corrected measured value is proportional to the number of gas molecules in the measurement beam path inside the measuring chamber, from which the concentration of the measuring gas in the measuring chamber is determined.

The signals sent from the radiation detectors, which represent the radiation output striking the detectors, are preferably pre-amplified and subsequently supplied to signal processing. Amplitude-dependent signals in the time-dependent signal progressions are derived for the particular signals.

The absorption signal and reference signal are preferably measured simultaneously for the measurement beam path and the auxiliary beam path. For this purpose, the modulable measurement radiation source and auxiliary radiation source are preferably controlled at the same frequency, but with a phase shift, so that from the detector signal separate signals may be derived for the measurement beam path and the auxiliary beam path. The phase shift by which the measurement radiation source and auxiliary radiation source are controlled is preferably 90°.

In another preferred method variant, the modulable measurement radiation source and auxiliary radiation source are controlled at different frequencies, so that from the simultaneously measured absorption signal and reference signal for the measurement beam path and auxiliary beam path separate signals may be derived for the measurement beam path and the auxiliary beam path. The measurement radiation source is preferably controlled at half the frequency at which the auxiliary radiation source is controlled.

In this referenced variant of the method according to the invention, in which the absorption signal and reference signal are measured simultaneously for the measurement beam path and the auxiliary beam path, the signals for the measurement beam path and auxiliary beam path must be separated by signal processing. This may preferably be achieved using synchronous rectifier pairs or digital signal processing. Thus, correct measurement results may be obtained even when interfering gas concentrations fluctuate in the dead spaces required for thermal decoupling and/or in the common radiation detector housing.

On the other hand, if partial leaks in the measuring chamber can be excluded and the load from high temperatures is not continuous, a discontinuous correction method may be used. In a discontinuous variant of the method, for determining the correction value from the auxiliary beam path the measurement radiation source is switched off and the auxiliary beam path is switched on, while for the actual measurement in the measurement beam path the auxiliary radiation source is switched off. The correction value may be determined at predefined time intervals, for example, once per day. From this correction value an absorption factor generated by the measuring gas or a measuring gas concentration present in the auxiliary beam path is calculated for the auxiliary beam path, which is used as a correction parameter for calculating the measuring gas concentration in normal operation, and thus when the measurement radiation source is switched on and the auxiliary radiation source is switched off. A synchronous rectifier pair may be omitted for this embodiment of the method.

Depending on the operating mode of the radiation sources and the signal processing, the amplitude values of the absorption signal and reference signal for the measurement beam path and auxiliary beam path may be detected either intermittently or simultaneously, and interferences from degassing effects or partial leaks corrected. In this regard, simultaneous detection of amplitude values of the absorption signal and reference signal for the measurement beam path and auxiliary beam path requires a frequency or phase difference between the modulation signal from the measurement radiation source and the auxiliary radiation source, as well as splitting of the signal processing of the time-dependent signal progressions of the absorption signal and reference signal, using in each case two synchronous rectifiers or appropriate digital filters.

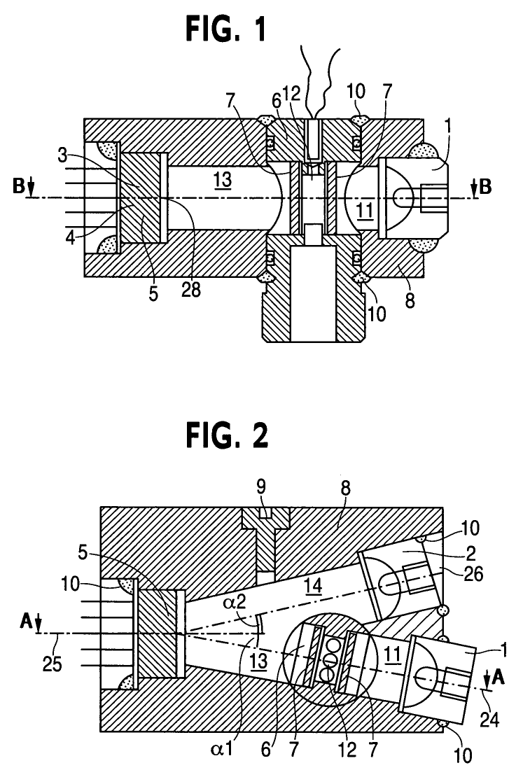

The invention is explained in greater detail below with reference to the exemplary embodiments illustrated in FIGS. 1 through 8.

The figures schematically show the following:

FIG. 1 shows an infrared gas sensor according to the invention in sectional representation along the plane A-A in FIG. 2;

FIG. 2 shows the same infrared gas sensor in sectional representation along the plane B-B in FIG. 1;

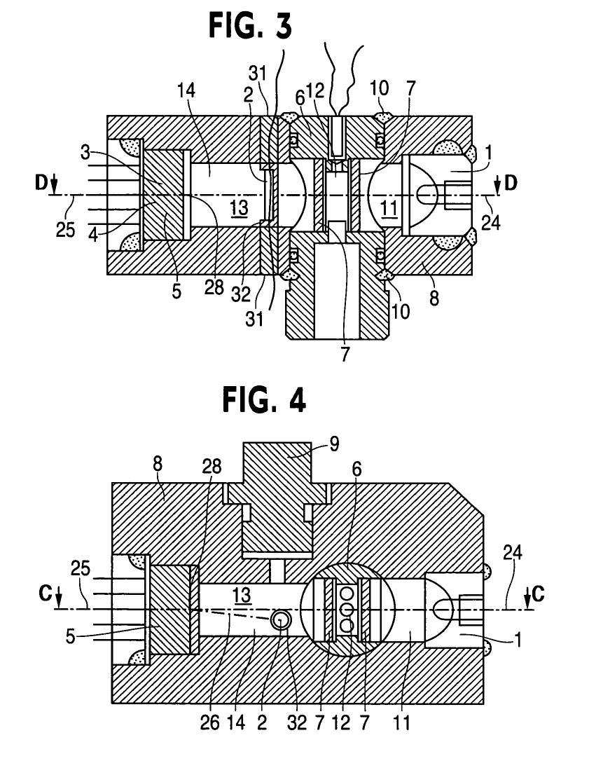

FIG. 3 shows another embodiment of the infrared gas sensor according to the invention with a simplified structure, in sectional representation along the sectional plane C—C in FIG. 4;

FIG. 4 shows the infrared gas sensor from FIG. 3 along the sectional plane D-D in FIG. 3;

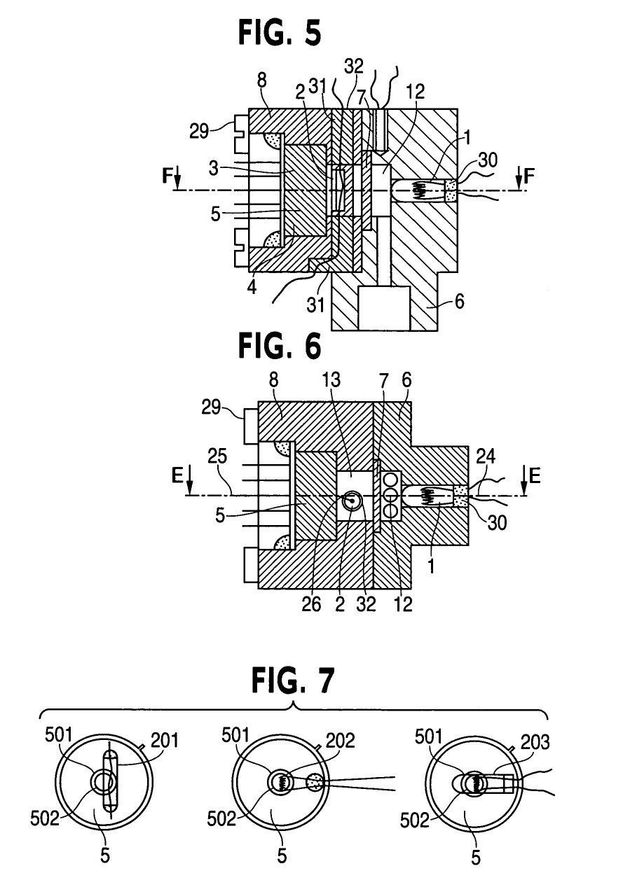

FIG. 5 shows a further simplified and reduced size infrared gas sensor in sectional representation along the plane E-E in FIG. 6;

FIG. 6 shows the embodiment of the infrared gas sensor according to the invention according to FIG. 5, along the sectional plane F-F from FIG. 5;

FIG. 7 shows various possible embodiments of the auxiliary radiation source and its configuration relative to its position in front of a detector housing; and

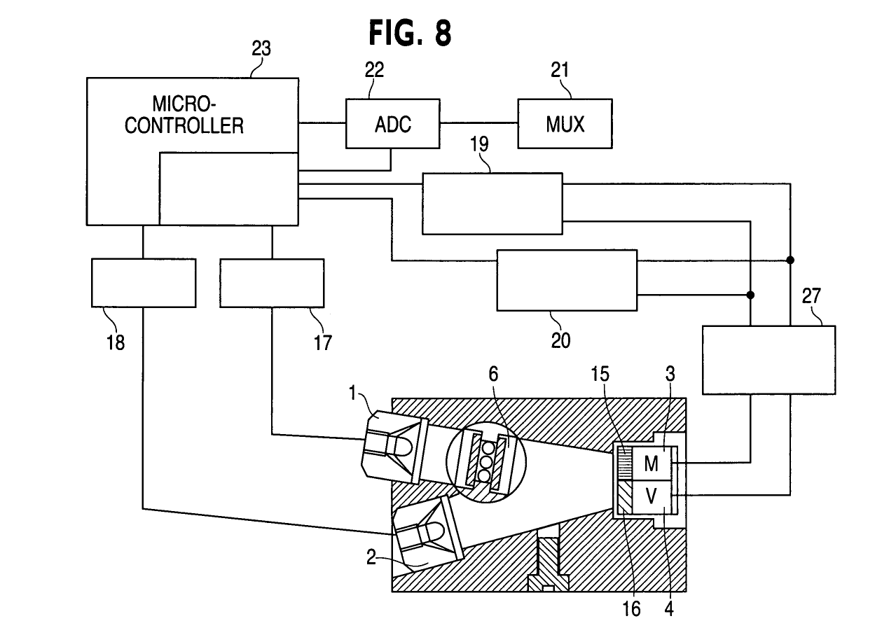

FIG. 8 shows an infrared gas sensor according to the invention in an embodiment according to FIG. 1 or 2, together with signal processing which allows the absorption values for the measurement beam path and auxiliary beam path to be detected simultaneously.

FIGS. 1 and 2, 3 and 4, and 5 and 6 each show different embodiments of the infrared gas sensor according to the invention. The embodiments in FIGS. 1 and 2 and FIGS. 3 and 4 are characterized by a higher temperature resistance compared to the embodiment of FIGS. 5 and 6, since the former embodiments have greater distances between the measuring chamber and the optical components, namely, the measurement radiation source 1 and radiation detectors 3, 4. In FIGS. 1 through 6 both radiation detectors 3 and 4 are accommodated together in one detector housing 5, and therefore are not illustrated in detail. In the embodiments of FIGS. 1 through 4, dead spaces 11 and 13 for thermal decoupling of the gas measurement path 12 and the optical and electronic components are located between the measuring chamber 6 and the detector housing 5, as well as between the measuring chamber 6 and the measurement radiation source 1. All dead spaces are connected to one another, so that all contain the same gas composition.

As shown in FIG. 2, the infrared gas sensor has an auxiliary beam path comprising an auxiliary radiation source 2, a dead space 14, and the radiation detectors 3 and 4 for the measurement beam path. The radiation detectors 3 and 4 are accommodated in a common housing 5. The intersection point of the optical axis 24 of the measurement beam path and the optical axis 26 of the auxiliary beam path lies within the detector housing 5 in the vicinity of the detector openings in the measurement detector 3 and reference detector 4. In this case both detectors are aligned in parallel, and the optical axis 24 of the measurement beam path and the optical axis 26 of the auxiliary beam path form acute angles α1 and α2 together with the surface normal on the plane encompassing the detector openings through the center of the opening in the detector housing. The angle and length ratios of the beam paths are selected so that the auxiliary radiation source 2 can irradiate past the measuring chamber 6 to the radiation detectors 3 and 4 in the detector housing 5, and that when the measuring gas concentration in the measuring chamber 6 is zero, the detector signals have essentially the same value, or are at least within the same order of magnitude, when irradiation is performed by only one of the radiation sources 1 or 2 at a time. The dead spaces 11 and 13 of the measurement beam path and dead space 14 of the auxiliary beam path, which are essentially gastight with respect to the outside, are connected to one another so that the same overall gas composition is present in the interior of the sensor housing 8, which is sealed essentially gastight, and in the interior of the measuring chamber. By use of a screw plug 9 the interior of the sensor housing may be flushed with gas in a defined manner during calibration, and during operation may be sealed essentially gastight.

FIGS. 3 and 4 show a simple design of an embodiment of the infrared gas sensor according to the invention in which the auxiliary radiation source 2 is installed in the dead space 13 required for thermal decoupling of the measuring chamber 6 and radiation detectors 3, 4. Omission of the V shape of the beam paths from the embodiment variants according to FIGS. 1 and 2 greatly simplifies manufacture of the sensor housing.

To insert the auxiliary radiation source 2, only one or two additional boreholes 31 must be provided in this sensor housing 8 of comparatively simple design, depending on the structural shape of the auxiliary radiation source 2. In this case, in comparison to the measurement radiation source, the distance from the auxiliary radiation source 2 to the radiation detectors 3 and 4 is considerably shorter. This creates the possibility of using an incandescent bulb or a specialized wire filament without a reflector.

When the measurement detector 3 and reference detector 4 are, for example, vertically positioned one on top of the other in the detector housing 5, the auxiliary radiation source can be installed in such a way that the radiation-emitting filament in the auxiliary radiation source is likewise vertically positioned and is situated in the beam path so that in the vertical direction it lies in the center between the detectors 3 and 4, and in the horizontal direction lies on the optical axis 24. A shade is preferably provided between the auxiliary radiation source 2 and measuring chamber 6. It is thus possible to avoid back reflection from the auxiliary radiation source 2 through the gas measurement path 12, which again strikes the radiation detectors 3, 4 through the gas measurement path 12 via the reflector in the measurement radiation source. If a microtube lamp 201 is used as the auxiliary radiation source 2, this shade may be eliminated by placing the microtube lamp completely inside a Teflon tube 32 which is cut out inside the desired irradiation region. As a result of the reflector in the measurement beam path, a majority of the radiation striking the aperture in the radiation detectors 3 and 4 comes from the external region of a radiation cone emitted from the measurement radiation source 1. This allows the auxiliary radiation source 2 to be situated in the center of the measurement beam path 13 on the optical axis 24. Although a certain portion of the radiation coming from the measurement radiation source is still shaded by the auxiliary radiation source 2, a sufficiently strong radiation signal is received. Even for a possible shift of the auxiliary radiation source 2 in the horizontal direction away from the optical axis 24 of the measurement beam path, the above-described alignment of the filament in the auxiliary radiation source 2 creates similar shading on the measurement detector 3 and reference detector 4.

In the embodiment of the infrared gas sensor illustrated in FIGS. 3 and 4, the sensor system may be equalized from a structural and electronic standpoint by maximizing the distance between the radiation detectors 3 and 4 and the auxiliary radiation source 2 over three degrees of freedom. One of these is the previously mentioned shift in the position of the auxiliary radiation source 2 in the horizontal direction from the center of the measurement beam path, thereby creating the angle discernible in FIG. 4 between the optical axis 24 of the measurement beam path and the optical axis 26 of the auxiliary beam path. Another possibility lies in controlling the output of the measurement radiation source 1, and a third possibility, controlling the output of the auxiliary radiation source 2. These three possibilities ensure that when the concentration of the measuring gas in the measuring chamber 6 is zero, the detector signals have essentially the same value, or are at least within the same order of magnitude when irradiation is performed by either only the measurement radiation source 1 or only the auxiliary radiation source 2.

FIGS. 5 and 6 show an additional simplified and smaller-sized embodiment of the infrared gas sensor according to the invention. If the maximum temperatures occurring in the measuring chamber 6 during operation do not destroy the optical components (radiation sources and detectors), the length of the measurement beam path may be shortened to a minimum value by, first, integrating the measurement radiation source 1 into the measuring chamber 6 and, second, minimizing the distance between the measuring chamber 6 and the radiation detector housing 5. This allows an incandescent bulb or reflector to be used as the measurement radiation source 1 by gluing same on the line feed 30 directly into the space 12 in the measuring chamber 6 that is accessible to the measuring gas. The dead space section 11 in the measurement beam path is thereby omitted, and only one additional infrared-transmitting window 7 is necessary. The sensor housing 8 may be reduced in size and adhesively bonded together with the measuring chamber 6 to the end face, and screwed in using screws 29. In this embodiment as well, the auxiliary radiation source 2 is installed in the dead space 13. As the auxiliary radiation source 2, once again a microtube lamp 201 may be used, the irradiation direction of which is specified by a cutout tube 32. The information provided for the embodiment in FIGS. 3 and 4 concerning the position of the optical axis 24 of the measurement beam path 13 and the optical axis 26 of the auxiliary beam path 14 and the surface normal 25 on the detector openings, as well as concerning the degrees of freedom for equalizing the infrared gas sensor, also applies to the embodiment according to FIGS. 5 and 6.

FIG. 7 shows various possible embodiments of the auxiliary radiation source 2 for the designs of the infrared gas sensor according to FIGS. 3 through 6 in their preferred configuration in front of the opening in the detector housing 5, as seen from the measurement radiation source 1. The illustrations apply to detectors 3 and 4 vertically positioned in the detector housing 5 one on top of the other, with a beam splitter situated upstream. The auxiliary radiation source 2 must be situated in the beam path in such a way that it has a minimal effect on the measurement beam path, and during operation generates a sufficiently strong measurement signal to the radiation detectors 3 and 4. The auxiliary radiation source 2 then sends a maximum signal to the radiation detectors 3 and 4 when it is positioned directly in front of the opening 501 of the radiation detector housing 5. In this case, however, the auxiliary radiation source also has a maximum screening effect on the radiation from the measurement beam path.

A diminished shading of the beam entry 502 into the beam splitter is achieved when the auxiliary radiation source 2 is moved from the center of the beam path. Moving the auxiliary radiation source 2 simultaneously attenuates the radiation from the auxiliary radiation source 2 which strikes the radiation detectors 3 and 4. So that the radiation detectors 3 and 4, which by arrangement are vertically positioned, are uniformly affected by the radiation attenuation when the auxiliary radiation source 2 is moved, the latter must be moved in the horizontal direction. So that, in turn, maximum radiation from the auxiliary radiation source 2 can strike the radiation detectors 3 and 4, the radiation element in the auxiliary radiation source 2 must likewise be vertically positioned. This results in the possible shapes and configurations of the auxiliary radiation source 2 in front of the radiation detector housing 5 shown in FIG. 7. Accordingly, a microtube lamp 201, a specially fabricated wire filament 202 without a glass tube, or also a miniature incandescent bulb 203 may be used as the auxiliary radiation source. Shading of the measurement beam path is at a minimum when a specially fabricated wire filament 202 without a glass tube is used, and is at a maximum when a miniature incandescent bulb 203 is used. With regard to insertion of the auxiliary radiation source into the measurement beam path, for the microtube lamp 201 two boreholes 31 are provided, whereas for the specially fabricated wire filament 202 and the miniature incandescent bulb 203 a single borehole is sufficient. With regard to control of the beam direction of the auxiliary radiation source 2, a microtube lamp 201 is most easily manipulated because it can be inserted into a cutout tubular section 32 before being glued into the sensor housing 8, as described above.

FIG. 8 shows the infrared gas sensor according to the invention, along with signal processing which allows simultaneous detection of the amplitude values of the absorption signal and reference signal for the measurement beam path and auxiliary beam path, with minimal load on the microcontroller 23.

The measurement radiation source 1 is controlled by the timer unit for the microcontroller 23 via the driver 17, based on control of the auxiliary radiation source, either at a different frequency, or at the same frequency with a phase shift. In this case, the phase shift is preferably 90°. This results in time lapses in the absorption signal and reference signal at the outputs of the radiation detectors 3 and 4 and of the preamplifier 27, which with appropriate control of the synchronous rectifier pairs 19 and 20 allow four signals to be derived. These signals correspond to the amplitude values of the absorption and reference signals when control is performed by only one respective radiation source. These signals are read into the microcontroller 23 via the multiplexer 21 and an analog-to-digital converter 22. From this information, within each calculation cycle the microcontroller calculates two absorption factors generated by the measuring gas for the measurement beam path and the auxiliary beam path. Using calibration functions, two measuring gas concentrations are then calculated in a known manner, and the raw measured value calculated for the measurement beam path is subsequently corrected using the concentration calculated for the auxiliary beam path. In this manner, correct measured values are obtained even when interfering gas concentrations fluctuate in the dead spaces 11, 13 required for thermal decoupling, and/or in the common radiation detector housing 5.

If a discontinuous correction method can be used, the necessary correction value is determined from the auxiliary beam path in such a way that the measurement radiation source 1 is switched off and the auxiliary radiation source 2 is switched on at predefined time intervals, preferably once per day. As described above, for the auxiliary beam path an absorption created by the measuring gas is calculated from this information, and a measuring gas concentration present in the auxiliary beam path is calculated therefrom which, in normal operation when the measurement radiation source 1 is switched on and the auxiliary radiation source 2 is switched off, is used by the microcontroller 23 as a correction parameter for calculating the measuring gas concentration in the measuring chamber. In this case, the second synchronous rectifier pair 20 may be omitted. If a microcontroller with sufficient computing power is used, the absorption signal and reference signal may be filtered in whole or in part by digital means, so that it is possible to either reduce the analog synchronous rectifier pairs 19, 20 to analog switches, or completely dispense with same.

1. An infrared gas sensor for determining the concentration of a measuring gas that absorbs infrared radiation, comprising a sensor housing containing two infrared radiation detectors adjacently situated on one end of a measurement beam path, and on the other end containing a measurement radiation source that emits infrared radiation, a measuring chamber accessible to the measuring gas being situated in this measurement beam path between the measurement radiation source and the detectors, at a distance from the detectors and sealed essentially gastight with respect to the remainder of the measurement beam path by at least one infrared-transmitting window; upstream from one detector, which functions as a measurement detector, an interference filter being provided whose transmission region lies at wavelengths that are absorbed by the measuring gas, and upstream from the other detector, which functions as a reference detector, an interference filter being provided whose transmission region lies at wavelengths that are not absorbed by gas that is present in the measuring chamber and in the measurement beam path, characterized in that an auxiliary radiation source is also provided inside the housing, between this auxiliary radiation source and the detectors an auxiliary beam path being situated which is not accessible to the measuring gas and which is connected to the portion of the measurement beam path that is not accessible to the measuring gas, so that the same gas composition is present in the entire portion of the measurement beam path that is not accessible to the measuring gas and in the auxiliary beam path, and that the system is selected in such a way that the measurement detector and reference detector can receive optical signals from both the measurement radiation source and the auxiliary radiation source.

2. The infrared gas sensor according to claim 1, wherein a beam splitter is installed in front of the interference filters which are provided upstream from the detectors, so that the ray bundles which strike the measurement detector and the reference detector come from the same ray bundle.

3. The infrared gas sensor according to claim 1, wherein the measurement beam path and/or the auxiliary beam path can be electrically modulated and independently controlled.

4. The infrared gas sensor according to claim 1, wherein the optical axis of the measurement beam path and/or the optical axis of the auxiliary beam path coincides with a surface normal on the plane encompassing the measurement detector opening as well as with a surface normal on the plane encompassing the reference detector opening, or forms an acute angle thereto.

5. The infrared gas sensor according to claim 1, wherein the measurement radiation source and/or the auxiliary radiation source is an incandescent bulb.

6. The infrared gas sensor according to claim 5, wherein the measurement radiation source is integrated into the measuring chamber.

7. The infrared gas sensor according to claim 1, wherein the measurement beam path and auxiliary beam path are situated in the sensor housing in such a way that the optical axes of both beam paths open up into a V shape from an intersection point in the vicinity of the detector openings toward the radiation sources, so that the auxiliary radiation source can irradiate both detectors past the measuring chamber in the measurement beam path.

8. The infrared gas sensor according to claim 1, wherein the auxiliary radiation source is situated in the measurement beam path between the measuring chamber and the detectors.

9. The infrared gas sensor according to claim 8, wherein the auxiliary radiation source is a microtube lamp or a wire filament without a glass tube.

10. The infrared gas sensor according to claim 1, wherein the auxiliary radiation source is movable and/or variable in its output.

11. A method for determining the concentration of a measuring gas that absorbs infrared radiation by use of an infrared gas sensor according to one of the preceding claims, wherein upstream from the measurement detector an interference filter is provided whose transmission region lies at wavelengths that are absorbed by the measuring gas, and that upstream from the reference detector an interference filter is provided whose transmission region lies at wavelengths that are not absorbed by the measuring gas and other gas components present in the measurement beam path and auxiliary beam path, that when the measurement radiation source in the measurement detector is switched on, an absorption signal that is attenuated as the result of absorption by the measuring gas is received in the transmission region of the interference filter provided upstream from the measurement detector, and in the reference detector an unattenuated reference signal is received in the transmission region of the interference filter provided upstream from the reference detector, and that these signals are relayed to a signal processing device in which a measured value is generated from the absorption signal and reference signal, the measured value being proportional to the number of measuring gas molecules in the measurement beam path, and that when the auxiliary radiation source is switched on, a measured value is generated in the same manner, which is proportional to the number of measuring gas molecules in the auxiliary beam path, and that, using this measured value for the auxiliary beam path, the measured value for the measurement beam path is corrected so that the corrected measured value is proportional to the number of gas molecules in the measurement beam path inside the measuring chamber, and that the concentration of the measuring gas in the measuring chamber is determined there from.

12. The method for measuring gas concentration according to claim 11, wherein the absorption signal and reference signal are measured simultaneously for the measurement beam path and the auxiliary beam path, the modulable measurement radiation source and auxiliary radiation source being controlled at the same frequency, but with a phase shift, so that from the detector signals separate signals may be derived for the measurement beam path and the auxiliary beam path.

13. The method for measuring gas concentration according to claim 12, wherein the phase shift is 90°.

14. The method for measuring gas concentration according to claim 11, wherein the absorption signal and reference signal are measured simultaneously for the measurement beam path and the auxiliary beam path, the modulable measurement radiation source and auxiliary radiation source being controlled at different frequencies, so that from the detector signals separate signals may be derived for the measurement beam path and the auxiliary beam path.

15. The method for measuring gas concentration according to claim 14, wherein the measurement radiation source is controlled at half the frequency at which the auxiliary radiation source is controlled.

16. The method for measuring gas concentration according to claim 11, wherein the separate signals for the measurement beam path and the auxiliary beam path are derived using synchronous rectifier pairs or digital signal processing.

17. The method for measuring gas concentration according to claim 11, wherein for determining the measured value for the auxiliary beam path, the measurement radiation source is switched off and the auxiliary radiation source is switched on, whereas for the measurement in the measurement beam path the auxiliary radiation source is switched off.
